(19) United States
(12) Patent Application Publication
(10) Pub. No.: US 2004/0100080 A1
(43) Pub. Date: May 27, 2004

(54) Expandable skin for safety restraint system

(76) Inventors: Todd DePue, Brighton, MI (US); Asad S. Ali, Troy, MI (US); Marc P. Beauregard, Berkley, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/306,634

(22) Filed: Nov. 27, 2002

(51) Int. Cl. B60R 21/22; B60R 21/16

(52) U.S. Cl. 280/743.1

(57) ABSTRACT

A safety restraint system wherein the system includes an expandable skin which inflates upon activation of the restraint system thereby eliminating the need for a separate inflatable bag and a hinged door through which the inflatable bag deploys, as required in a conventional safety restraint system.

### FIELD OF THE INVENTION

The invention relates to a safety restraint system and more particularly to an expandable skin for a safety restraint system wherein the expandable skin eliminates the need for a separate inflatable bag and a hinged door through which the inflatable bag deploys of a conventional safety restraint system.

### BACKGROUND OF THE INVENTION

In the automotive industry, air bag safety restraint systems are standard equipment in many passenger vehicles. Typically, the safety restraint system is mounted in a dashboard and/or a steering wheel assembly of a motor vehicle. While the particular location of such safety restraint systems may vary, each is typically designed for installation as a modular assembly. A conventional air bag module contains an inflator, a folded air bag, and a deployment housing within which the air bag and the inflator are mounted. The air bag is deployed through a hinged door. The deployment housing is typically secured to a rigid support structure within vehicle components such as the steering wheel assembly, the dashboard, the door panel, or other location as desired, for example.

Air bag safety restraint devices are typically mounted in a position to protect a passenger's upper torso, head, and legs when deployed during an accident. The use of air bag safety restraint systems, particularly in conjunction with the use of seat belts, has proven to reduce the severity of injuries and increase the survival rate of passengers involved in an accident.

It is also known in the art to deploy an air bag through a hinged door. Upon deployment during an accident, a seam in a trim panel is caused to open allowing the hinged doors to swing outwardly and release the air bag. Injury may result during the accident if the passenger is brought into contact with the exposed door.

It would be desirable to produce a safety restraint system for a vehicle which eliminates the need for hinged doors and militates against injury of a passenger from operation of the air bag.

### SUMMARY OF THE INVENTION

Consistent and consonant with the present invention, a safety restraint system for an automobile which eliminates the need for hinged doors and militates against injury of a passenger from operation of the air bag has surprisingly been discovered.

The safety restraint system for a vehicle comprises:

a housing adapted to be attachable to a structural member;

an expandable skin covering at least a portion of an outer surface of the housing; and

an inflator for injecting a fluid between facing surfaces of the housing and the skin.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is partial sectional view of a safety restraint system in accordance with the present invention; and

FIG. 2 is a partial sectional view of the safety restraint system illustrated in FIG. 1 showing the restraint system in a deployed position.

### DESCRIPTION OF THE PREFERRED EMBODIMENT

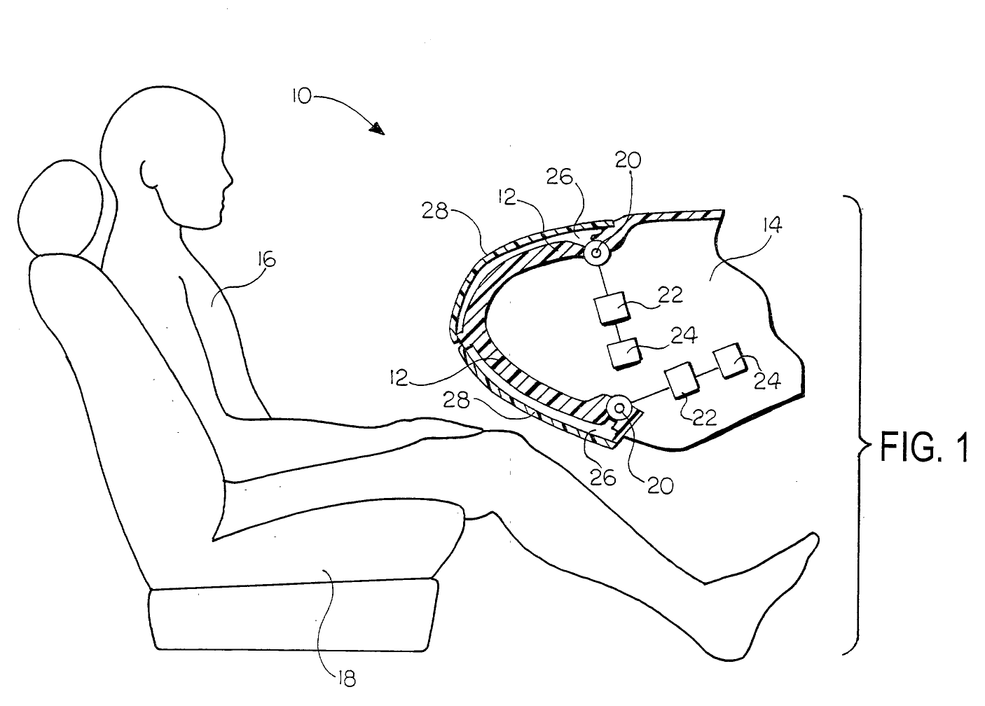

Referring now to the drawings, and particularly FIG. 1, there is shown generally at 10 an air bag safety restraint system incorporating the features of the present invention. The safety restraint system 10 includes a restraint housing 12. The housing 12 is attached to a structural member or component 14 of a vehicle (not shown). In the embodiment shown, the structural component 14 is a dashboard. It is understood, however, that other structural components could be used without departing from the scope and spirit of the invention such as a steering wheel, a door frame, a seat back, or a roof of a passenger compartment, for example. The housing 12 is located as desired in the vehicle to protect a passenger 16 seated in a seat 18 of a passenger compartment of the vehicle.

An inflator 20 is disposed in the housing 12. An actuator 22 which is activated by a sensor 24 operates the inflator 20. The inflator 20 is in communication with an air gap 26. In the embodiment shown, the inflator 20 is disposed in the housing 12. However, other configurations can be used without departing from the scope and spirit of the invention. An expandable skin 28 cooperates with the housing 12 to form the air gap 26 and sealingly close the air gap 26 from the atmosphere. It is understood that the expandable skin 28 could be disposed in direct contact with an outer surface of the housing 12. Additionally, the expandable skin 28 could be disposed directly on the structural component 14 of the vehicle, thus eliminating the need for the housing 12.

In the embodiment shown, the expandable skin 28 is formed by a urethane resin or urethane elastomer. The liquid urethane gel is blended with dye and injected into a mold to form into a sheet of desired dimensions. Although materials having other properties and dimensions may be acceptable for use in forming the expandable skin 28, a urethane elastomer having the following properties and dimensions has been found to perform satisfactorily for forming the expandable skin 28 during testing of the expandable skin 28 of the safety restraint system 10:

| | |
|---|---|
| Hardness (Shore A): | 70-90 |
| Tensile strength: | 40-50 Kg/cm |
| Elongation: | 400-500% |
| Sheet thickness: | 1.5-20 mm (3-5 mm desirable) |
| Width: | 900 mm |
| Length: | 1800 mm |

It is understood that other conventional materials could be used to form the expandable skin 28 without departing from the scope and spirit of the invention. Additionally, although shown as an integral part of the housing 12, the expandable skin 28 can be made as a replaceable portion of the housing 12 to facilitate removal and replacement of the expandable skin 28 without having to remove the housing 12 from the structural component 14.

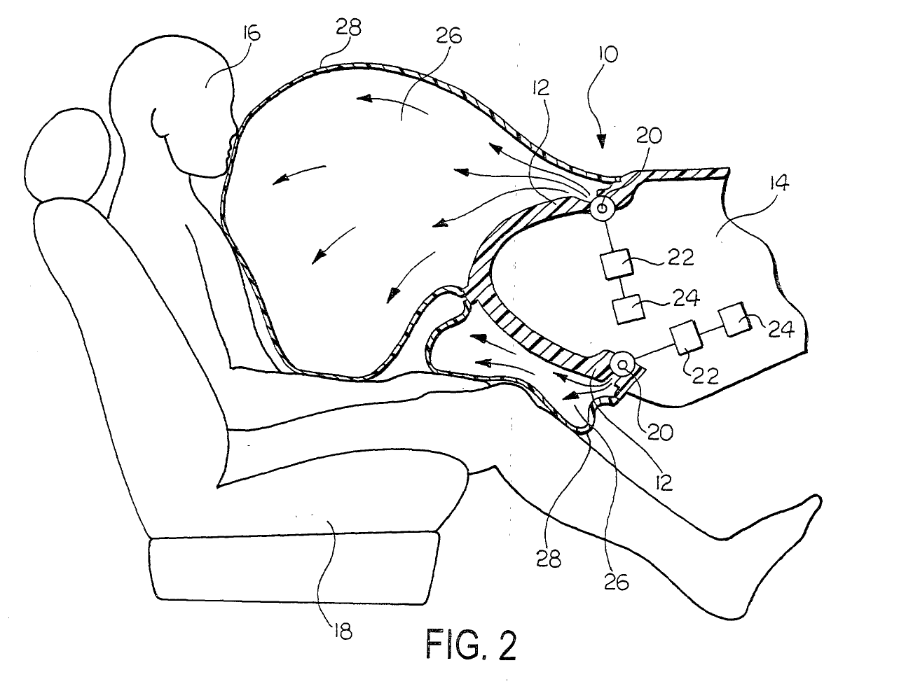

In operation, the restraint system 10 serves as one of a number of safety components in a vehicle. During an accident, the actuator 22 connected to the inflator 20 receives a signal from the sensor 24, thereby causing the inflator 20 to operate. During operation, the inflator 20 rapidly causes a fluid, typically a gas, to flow into the air gap 26 causing the air gap 26 to become pressurized and exert a force on the expandable skin 28. During pressurization of the air gap 26, the expandable skin 28 begins to move outwardly from the housing 12, thereby expanding the volume of the air gap 26. The expandable skin 28 continues to move outwardly and expand to come into contact with the passenger 16 to function as an air bag, as illustrated in FIG. 2. The contact between the passenger 16 and the expandable skin 28 militates against the passenger 16 being caused to lurch forward and into contact with interior components of the vehicle such as the steering wheel, the dash, and the like. By preventing contact between the passenger 16 and the interior components of the vehicle, the expandable skin 28 militates against injury of the passenger 16.

The expandable skin 28 can be formed into most shapes structures, and contours. Additionally, different colors, including transparent materials, can be used to form the expandable skin 28. Based on the flexibility in selecting the shape, color, etc. of expandable skin 28 material, the expandable skin 28 can be used to form various vehicle passenger cabin components such as seats (insert pads, bolsters, armrests), an instrument panel (face material, air bag cover), head impact and knee bolsters, and other interior components.

Use of the restraint system 10 of the invention results in a reduction in required components from a typical air bag system. Generally, a folded or otherwise concealed bag is disposed behind at least one hinged door. Upon activation of an inflator, the air bag is inflated, causing the at least one door to open. Typically, the at least one door is in the form of a trim component in the interior of the vehicle. Using the embodiment of the invention described, the at least one door is eliminated since the trim component itself is the air bag. Thus, the number of parts and the cost thereof are minimized, while possible contact by the passenger with the parts eliminated is militated against. Contact between the passenger and the parts which were eliminated could result in an undesirable injury to the passenger.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A safety restraint comprising:
a housing adapted to be attachable to a structural member;
an expandable skin covering at least a portion of an outer surface of said housing; and
an inflator for injecting a fluid between facing surfaces of said housing and said skin.

2. The safety restraint according to claim 1 wherein said expandable skin and said housing cooperate to form an air gap therebetween, said inflator being in fluid communication with the air gap.

3. The safety restraint according to claim 1 wherein said skin is formed from a urethane elastomer.

4. The safety restraint according to claim 1 wherein said skin has a tensile strength of 40 to 50 kilograms per centimeter.

5. The safety restraint according to claim 1 wherein said skin sustains an elongation of up to 500 percent.

6. A safety restraint for a vehicle comprising:
a housing adapted to be attachable to a structural member of the vehicle;
an expandable skin covering at least a portion of an outer surface of said housing; and
an inflator for injecting a fluid between facing surfaces of said housing and said skin.

7. The safety restraint according to claim 6 wherein said expandable skin and said housing cooperate to form an air gap therebetween, said inflator being in fluid communication with the air gap.

8. The safety restraint according to claim 6 wherein said skin is formed from a urethane elastomer.

9. The safety restraint according to claim 6 wherein said skin has a tensile strength of 40 to 50 kilograms per centimeter.

10. The safety restraint according to claim 6 wherein said skin sustains an elongation of up to 500 percent.

11. The safety restraint according to claim 6 wherein the structural member is a dashboard.

12. The safety restraint according to claim 6 wherein the structural member is a steering wheel.

13. The safety restraint according to claim 6 wherein the structural member is a door frame.

14. The safety restraint according to claim 6 wherein the structural member is a seat back.

15. The safety restraint according to claim 6 wherein the structural member is a roof panel of a passenger compartment of the vehicle.

16. A safety restraint for a vehicle comprising:
an expandable skin covering at least a portion of an outer surface of a structural member of the vehicle; and
an inflator for injecting a fluid between facing surfaces of said skin and the outer surface of the structural member of the vehicle.

17. The safety restraint according to claim 16 wherein said expandable skin and the structural member cooperate to form an air gap therebetween, said inflator being in fluid communication with the air gap.

18. The safety restraint according to claim 6 wherein said skin is formed from a urethane elastomer.

19. The safety restraint according to claim 6 wherein said skin has a tensile strength of 40 to 50 kilograms per centimeter.

20. The safety restraint according to claim 6 wherein said skin has sustains an elongation of up to 500 percent.
